(19) United States
(12) Patent Application Publication
(10) Pub. No.: US 2026/0336372 A1
(43) Pub. Date: Oct. 29, 2026

(54) WEATHER STRIP

(71) Applicant: TOKAI KOGYO CO., LTD., Obu-shi, Aichi (JP)

(72) Inventors: Keigo CHIBA, Obu-shi (JP); Yuki KONDO, Obu-shi (JP)

(73) Assignee: TOKAI KOGYO CO., LTD., Obu-shi, Aichi (JP)

(21) Appl. No.: 19/103,684

(22) PCT Filed: Aug. 2, 2023
(86) PCT No.: PCT/JP2023/028353

§ 371 Date: Feb. 13, 2025

(30) Foreign Application Priority Data
Sep. 22, 2022 (JP) 2022-152004

(51) Int. Cl. B60J 10/84; B60J 10/246

(52) U.S. Cl. CPC B60J 10/84; B60J 10/246

(57) ABSTRACT

A weather strip includes a hollow seal portion configured to be compressed and deformed by abutting against a door when the door is closed, and a mounting portion for mounting the hollow seal portion on an opening of a vehicle body. The hollow seal portion includes a head side wall portion located on a side opposite to the mounting portion, and bending portions adjacent to both sides of the head side wall portion. In the hollow seal portion, a protruding portion that protrudes from an inner wall surface of the head side wall portion is formed of the same material as the hollow seal portion, and the a protruding portion is formed such that a distal end of the protruding portion does not abut against an inner wall surface of the hollow seal portion when the hollow seal portion is compressed and deformed by closing the door.

### TECHNICAL FIELD

The present invention relates to a long weather strip that seals between the peripheral edge of an opening in the vehicle body and an opening and closing member, such as a door, that opens and closes the opening when the opening and closing member is closed.

### BACKGROUND ART

In general, the weather strip is attached to the attachment location of either the peripheral edge of the opening of the vehicle body and an opening and closing member such as a door, and includes a hollow seal portion that can be compressed and deformed by abutting against the other of the peripheral edge of the opening of the vehicle body and the opening and closing member when the opening and closing member is closed. In this type of weather strip, as described in Patent Literature 1 (JP2010-058637A), it is known that a hollow cylindrical wall portion made of a different material is provided within the hollow seal portion in order to improve sound insulation, and a plurality of uneven portions are formed on the inner peripheral surface of this cylindrical wall portion. Further, in the weather strip in Patent Literature 1, the cylindrical wall portion is made of a sponge material having a specific gravity lower than the specific gravity of the molding material of the hollow seal portion, thereby preventing the compressive load on the hollow seal portion from becoming large when the door is closed, thereby preventing a deterioration in the door closing ability.

### CITATION LIST

### Patent Literature

Patent Literature 1: JP2010-058637A

### SUMMARY OF INVENTION

### Technical Problem

In general, the weather strip is formed by extrusion molding of a polymer material, but in the configuration in Patent Literature 1 described above, the hollow seal portion and the inner cylindrical wall portion are formed of different materials, which requires additional extrusion molding device used at the time of extrusion molding of the weather strip, resulting in the disadvantages of complex molding equipment and high production costs.

Therefore, the problem that the present invention aims to solve is to provide a weather strip that can reduce sound entering the vehicle interior without increasing the number of types of materials used to mold the weather strip, and can prevent an increase in the compression load on a hollow seal portion when an opening and closing member is closed, thereby preventing a deterioration in the closing ability of the opening and closing member.

### Solution to Problem

In order to solve the problem described above, the invention according to an aspect 1 provides a long weather strip for sealing between a peripheral edge of an opening of a vehicle body and an opening and closing member configured to open and close the opening when the opening and closing member is closed. The weather strip includes: a hollow seal portion attached to a mounting location of one of the peripheral edge of the opening of the vehicle body and the opening and closing member, the hollow seal portion being configured to be compressed and deformed by abutting against the other of the peripheral edge of the opening of the vehicle body and the opening and closing member when the opening and closing member is closed; and a mounting portion configured to mount the hollow seal portion on the mounting location. The hollow seal portion includes a head side wall portion that is located on a side opposite to the mounting portion, and a bending portion adjacent to both sides of the head side wall portion and configured to bend when the opening and closing member is closed. In the hollow seal portion, a protruding portion that protrudes from an inner wall surface of the head side wall portion is formed of the same material as the hollow seal portion. The protruding portion is formed such that a distal end of the protruding portion does not abut against an inner wall surface of the hollow seal portion when the hollow seal portion is compressed and deformed by closing the opening and closing member.

In this configuration, the hollow cylindrical wall portion made of a different material is not provided in the hollow seal portion, and the protruding portion does not protrude from the bending portion of the hollow seal portion. Therefore, it is possible to prevent an increase in the compressive load of the hollow seal portion when the opening and closing member is closed, thereby preventing a deterioration in the closing ability of the opening and closing member. Furthermore, in the hollow seal portion, since the protruding portion that protrudes from the inner wall surface of the head side wall portion is formed of the same material as the hollow seal portion, there is no need to increase the types of materials used to mold the weather strip, and there is no need to increase the number of extrusion molding devices used at the time of extrusion molding of the weather strip, thereby reducing the production cost.

Further, the protruding portion protrudes from the inner wall surface of the head side wall portion so that the sound that enters the hollow seal portion from the head side wall portion of the hollow seal portion easily hits the protruding portion. Therefore, when the opening and closing member is closed, the sound that enters the hollow seal portion hits the protruding portion in the hollow seal portion, so that the energy of the sound that enters the hollow seal portion is attenuated, and the sound that enters the vehicle interior can be reduced. Furthermore, the protruding portion in the hollow seal portion is formed such that the distal end of the protruding portion does not abut against the inner wall surface of the hollow seal portion when the hollow seal portion is compressed and deformed when the opening and closing member is closed. Therefore, the space within the hollow seal portion is not blocked by the protruding portion, and the sound that enters the hollow seal portion is prevented from being reflected and resonated in the narrow space blocked by the protruding portion, thereby preventing the sound from being amplified.

Further, as in an aspect 2, the protruding portion may be formed in a lip shape extending into the hollow seal portion. The protruding portion has a lip shape, so that the sound that enters the hollow seal portion is more likely to hit the protruding portion, thereby improving the effect of reducing the sound.

Further, as in an aspect 3, the protruding portion may include a plurality of protruding portions, and each of the protruding portions may be formed at a plurality of locations on the inner wall surface of the head side wall portion at a predetermined interval. In this way, the probability that the sound entering the hollow seal portion hits the protruding portions is increased, thereby improving the effect of reducing the sound.

In this case, as in an aspect 4, the protruding portions may be formed, in the inner wall surface of the hollow seal portion, on both the inner wall surface of the head side wall portion and a different inner wall surface other than the inner wall surface of the head side wall portion, such that the protruding portions do not abut against each other when the hollow seal portion is compressed and deformed by closing the opening and closing member. In this way, the plurality of protruding portions formed on both the inner wall surface of the head side wall portion of the hollow seal portion and the inner wall surface on the opposite side efficiently attenuate the energy of the sound that enters the hollow seal portion, thereby improving the effect of reducing the sound.

As in an aspect 5, the bending portion may be thinner than a portion of the hollow seal portion other than the bending portion. In this way, it is possible to easily form the bending portion of the hollow seal portion that is more easily bent than the other portions.

As in an aspect 6, the weather strip according to the present invention may be applied to a door opening that is attached to the peripheral edge of the opening of the vehicle body. This is because the weather strip used for the door opening has a large space in the hollow seal portion and easily forms the protruding portion.

### BRIEF DESCRIPTION OF DRAWINGS

FIG. 1 is a side view showing a schematic configuration of an automobile to which a weather strip according to an embodiment 1 of the present invention is attached;

FIG. 2 is a cross-sectional view taken along a line A-A in FIG. 1, showing the weather strip attached to the peripheral edge of the front door opening when the front door is open;

FIG. 3 is a cross-sectional view taken along a line A-A in FIG. 1, showing the weather strip attached to the peripheral edge of the front door opening when the front door is closed;

FIG. 4 is a view corresponding to FIG. 2, showing an embodiment 2 of the present invention;

FIG. 5 is a view corresponding to FIG. 2, showing an embodiment 3 of the present invention;

FIG. 6 is a cross-sectional view of a weather strip attached to the front door according to an embodiment 4 of the present invention;

FIG. 7 is a cross-sectional view of a weather strip attached to the peripheral edge of a back door opening according to an embodiment 5 of the present invention; and

FIG. 8 is a diagram showing the results of an evaluation test of the effect of reducing the sound according to the embodiments 1 to 3 and a comparative example.

### DESCRIPTION OF EMBODIMENTS

Hereinafter, several embodiments in which the present invention is applied to a door opening will be described.

### Embodiment 1

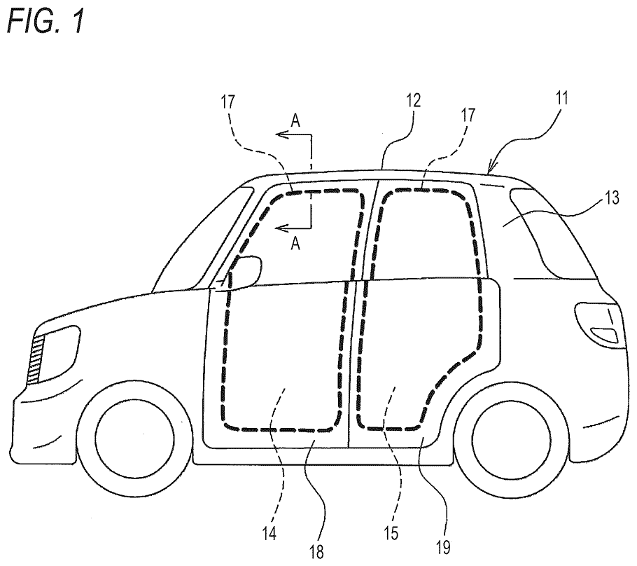

An embodiment 1 of the present invention will be described with reference to FIGS. 1 to 3.

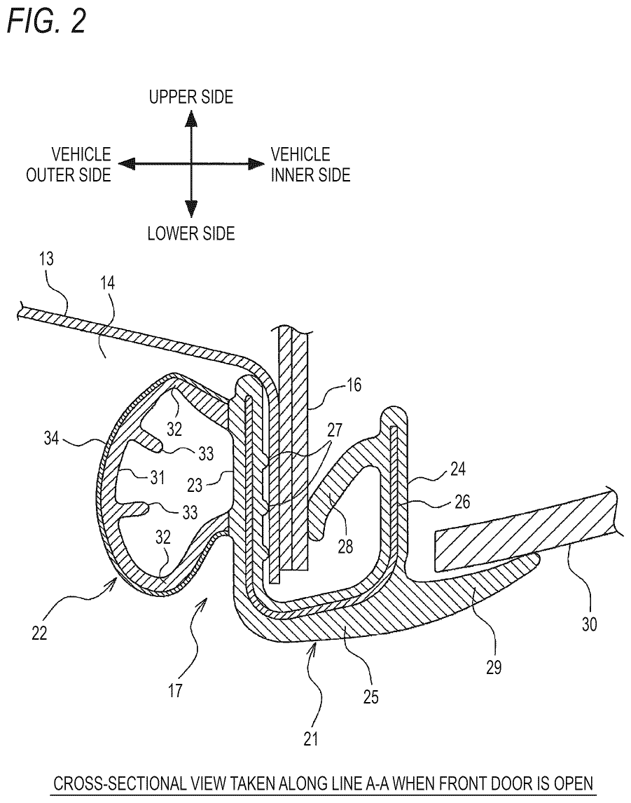

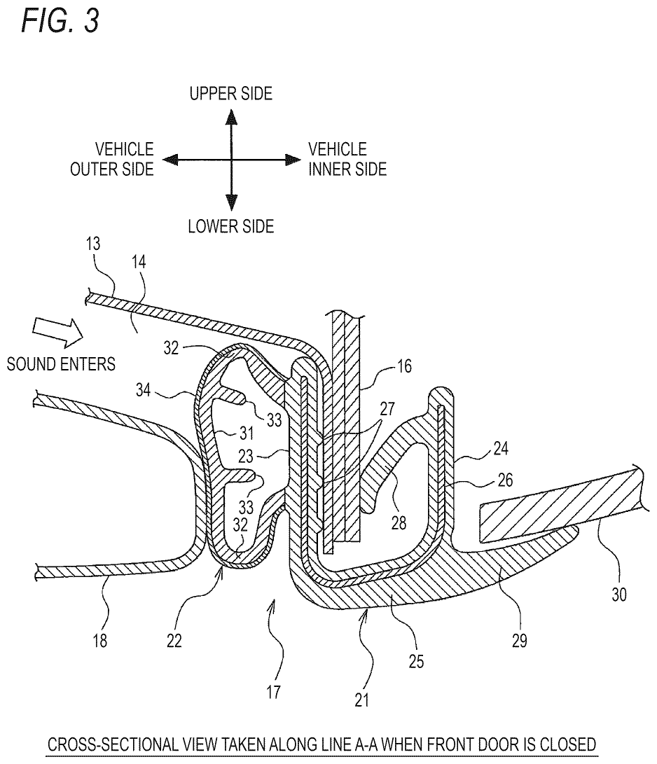

As shown in FIG. 1, a vehicle body 11 of an automobile is implemented by joining together a plurality of panels such as a roof panel 12 and a side panel 13. A weather strip 17 (a door opening) formed in a long shape by extrusion molding of an elastic polymer material is attached to a flange 16 (see FIGS. 2 and 3) provided along the peripheral edge of a front door opening 14 and a rear door opening 15 of the vehicle body 11. The front side weather strip 17 seals between the peripheral edge of the front door opening 14 and a front door 18 (an opening and closing member) that opens and closes the front door opening 14 when the front door 18 is closed. The rear side weather strip 17 seals between the peripheral edge of the rear door opening 15 and a rear door 19 (an opening and closing member) that opens and closes the rear door opening 15 when the rear door 19 is closed.

Next, the configuration of the weather strip 17 will be described with reference to FIGS. 2 and 3.

The weather strip 17 according to the embodiment 1 is made of, for example, ethylene propylene diene rubber (EPDM), but is not limited thereto and may be made of any elastic polymer material, such as a thermoplastic synthetic resin (including a thermoplastic elastomer). In order to reduce the weight of the weather strip 17, a foaming agent or a microcapsule may be mixed into a polymer material such as ethylene propylene diene rubber. As the foaming agent, for example, a chemical foaming agent such as OBSH may be used.

The weather strip 17 includes a mounting portion 21 that has a U-shaped cross section and that is attached to the flange 16 provided along the peripheral edge of the front door opening 14 (the rear door opening 15), and a cylindrical hollow seal portion 22 that is integrally formed with the mounting portion 21 on the outer side of the vehicle. The mounting portion 21 and the hollow seal portion 22 extend in the longitudinal direction of the weather strip 17 by extrusion molding.

The mounting portion 21 is integrally formed with a vehicle outer side wall portion 23, a vehicle inner side wall portion 24, and a top wall portion 25 connecting both side wall portions 23 and 24, and a hollow seal portion 22 is integrally formed on the outer surface of the vehicle outer side wall portion 23. In the mounting portion 21, a core material 26 that has a substantially U-shaped cross section and that is made of a metal plate, a resin plate, or the like is embedded across both side wall portions 23 and 24 by composite extrusion molding.

A plurality of protrusions 27 that protrude toward the vehicle inner side wall portion 24 are integrally formed at a predetermined interval on the inner side surface of the vehicle outer side wall portion 23, and a holding lip 28 protruding obliquely downward toward the vehicle outer side wall portion 23 is integrally formed on the inner side surface of the vehicle inner side wall portion 24. When the weather strip 17 is attached, the gap between both side wall portions 23 and 24 of the mounting portion 21 is inserted into the flange 16 on the peripheral edge of the front door opening 14 (the rear door opening 15), so that the holding lip 28 abuts against the flange 16 and elastically deforms. The elastic rebound force of the holding lip 28 causes the flange 16 to be sandwiched between the holding lip 28 and the plurality of protrusions 27 of the vehicle outer side wall portion 23, and the weather strip 17 is attached to the flange 16.

A decorative lip 29 that protrudes toward the vehicle inner side is integrally formed on the top wall portion 25 of the mounting portion 21, and this decorative lip 29 covers and hides the gap between the mounting portion 21 and an interior material 30 on the vehicle inner side.

As shown in FIG. 3, the hollow seal portion 22 abuts against the peripheral edge of the front door 18 (the rear door 19) and is compressed and deformed when the front door 18 (the rear door 19) is closed, thereby sealing between the peripheral edge of the front door 18 (the rear door 19) and the peripheral edge of the front door opening 14 (the rear door opening 15).

The hollow seal portion 22 includes a head side wall portion 31 that is located on a side opposite to the mounting portion 21, and bending portions 32 that are adjacent to both sides of the head side wall portion 31 and that are more easily bent than the other portions of the hollow seal portion 22. The bending portion 32 is thinner than the other portions of the hollow seal portion 22, so that the bending portion 32 is easier to bend than the other portions of the hollow seal portion 22. Accordingly, it is possible to more easily form the bendable bending portion 32 and the other portions of the hollow seal portion 22 by extrusion molding.

At a plurality of locations on the inner wall surface of the head side wall portion 31 of the hollow seal portion 22, a plurality of lip-shaped protruding portions 33 that protrude into the hollow seal portion 22 from the inner wall surface of the head side wall portion 31 are integrally formed of the same material as the hollow seal portion 22 at a predetermined interval. The protruding portions 33 are formed such that the distal ends of the protruding portions 33 do not abut against the inner wall surface of the hollow seal portion 22 when the hollow seal portion 22 is compressed and deformed when the front door 18 (the rear door 19) is closed, and further, the protruding portions 33 are formed at a position where the protruding portions 33 do not abut against each other. The protruding portions 33 have a lip shape extending in the longitudinal direction of the weather strip 17 by extrusion molding.

In this case, in order to ensure that sound entering the hollow seal portion 22 from outside the vehicle is likely to hit the protruding portions 33, it is desirable to set the protruding length of the protruding portions 33 to, for example, 0.5 mm or more, within a range in which the distal ends of the protruding portions 33 do not abut against the inner wall surface of the hollow seal portion 22 when the hollow seal portion 22 is compressed and deformed when the front door 18 (the rear door 19) is closed. This is because the larger the protruding length of the protruding portions 33, the more likely sound that enters the hollow seal portion 22 hits the protruding portions 33.

Further, a covering portion 34 is formed on the surface of the hollow seal portion 22 to improve the wear resistance of the surface. The covering portion 34 is made of, for example, a rubber material having a specific gravity of 1.2 or more and 1.5 or less, and is formed by co-extrusion molding when the weather strip 17 is molded.

The hollow seal portion 22 and the protruding portion 33 are formed of, for example, a rubber material having a specific gravity of 0.2 or more and 1.0 or less. The mounting portion 21, the holding lip 28, and the protrusion 27 are formed of, for example, a rubber material having a specific gravity of 0.6 or more and 1.5 or less.

In the weather strip 17 according to the embodiment 1 described above, a hollow cylindrical wall portion made of a different material is not provided in the hollow seal portion 22, and the bending portion 32 of the hollow seal portion 22 bends more easily than the other portions, thereby preventing an increase in the compressive load of the hollow seal portion 22 when the front door 18 (the rear door 19) is closed, and preventing a deterioration in the closing ability of the front door 18 (the rear door 19). Furthermore, since the protruding portion 33 that protrudes from the inner wall surface of the hollow seal portion 22 is formed of the same material as the hollow seal portion 22, there is no need to increase the types of materials used to mold the weather strip 17, and there is no need to increase the number of extrusion molding devices used at the time of extrusion molding of the weather strip 17, thereby reducing the production cost.

Further, the protruding portion 33 protrudes from the inner wall surface of the head side wall portion 31 so that the sound that enters the hollow seal portion 22 from the head side wall portion 31 of the hollow seal portion 22 easily hits the protruding portion 33. Therefore, when the front door 18 (the rear door 19) is closed, the sound that enters the hollow seal portion 22 hits the protruding portion 33 in the hollow seal portion 22, so that the energy of the sound that enters the hollow seal portion 22 is attenuated, and the sound that enters the vehicle interior can be reduced. Furthermore, the protruding portion 33 in the hollow seal portion 22 is formed such that the distal end of the protruding portion 33 does not abut against the inner wall surface of the hollow seal portion 22 when the hollow seal portion 22 is compressed and deformed when the front door 18 (the rear door 19) is closed. Therefore, the space within the hollow seal portion 22 is not blocked by the protruding portion 33, and the sound that enters the hollow seal portion 22 is prevented from being reflected and resonated in the narrow space blocked by the protruding portion 33, thereby preventing the sound from being amplified.

Further, in the embodiment 1, the protruding portion 33 is formed in a lip shape extending into the hollow seal portion 22. Therefore, the sound that enters the hollow seal portion 22 is more likely to hit the protruding portion 33, thereby improving the effect of reducing the sound. Furthermore, since the plurality of protruding portions 33 are formed at a predetermined interval on the inner wall surface of the hollow seal portion 22, the probability that the sound entering the hollow seal portion 22 hits the protruding portions 33 is increased, thereby improving the effect of reducing the sound.

Since the protruding portion 33 does not protrude from the bending portion 32, it is possible to prevent the bending portion 32 from becoming difficult to bend.

### Embodiment 2

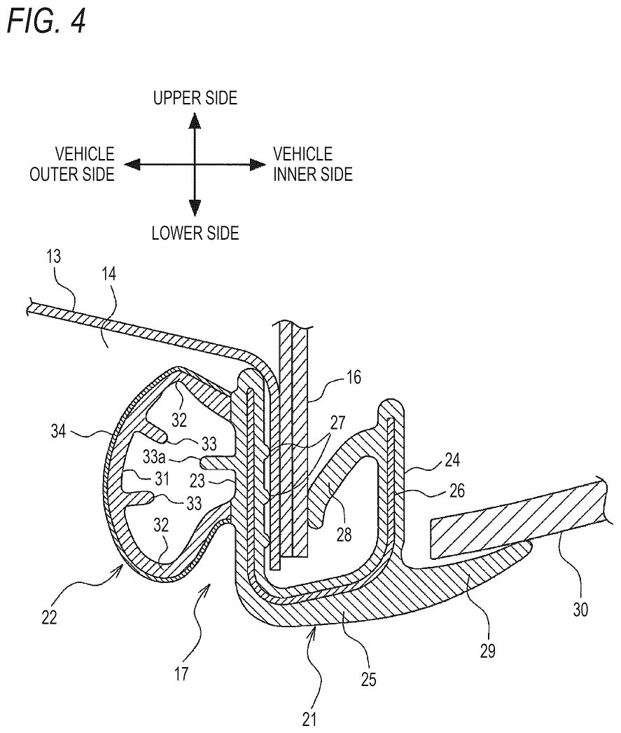

Next, an embodiment 2 of the present invention will be described with reference to FIG. 4. Components that are substantially the same as those in the embodiment 1 described above are denoted by the same reference signs as those in the embodiment 1 described above, the description thereof will be omitted or simplified, and mainly the different components are given different reference signs and described.

In the embodiment 1 described above, the protruding portion 33 that protrudes into the hollow seal portion 22 is formed only on the inner wall surface of the head side wall portion 31 of the hollow seal portion 22. In the embodiment 2, protruding portions 33 and 33a having a lip shape are integrally formed on both the inner wall surface of the head side wall portion 31 of the hollow seal portion 22 and the inner wall surface (the vehicle outer side wall surface of the vehicle outer side wall portion 23 of the mounting portion 21) on the opposite side so as to protrude into the hollow seal portion 22. The protruding portions 33 and 33a have a lip shape extending in the longitudinal direction of the weather strip 17 by extrusion molding.

A protruding portion that protrudes into the hollow seal portion 22 may also be formed on the inner wall surface among the inner wall surfaces of the hollow seal portion 22 from the bending portion 32 to the vehicle outer side wall portion 23. In other words, a protruding portion that protrudes into the hollow seal portion 22 may also be formed on the inner wall surface among the inner wall surfaces of the hollow seal portion 22 in a portion other than the head side wall portion 31.

In this case, the protruding lengths and the forming positions of the protruding portions 33 and 33a are set such that when the hollow seal portion 22 is compressed and deformed when the front door 18 (the rear door 19) is closed, the distal ends of the protruding portions 33 and 33a do not abut against the inner wall surface of the hollow seal portion 22 and the protruding portions 33 and 33a do not abut against each other.

In the weather strip 17 according to the embodiment 2 described above, the plurality of protruding portions 33 and 33a formed on both the inner wall surface of the head side wall portion 31 of the hollow seal portion 22 and the inner wall surface (the vehicle outer side wall surface of the vehicle outer side wall portion 23 of the mounting portion 21) on the opposite side efficiently attenuate the energy of the sound that enters the hollow seal portion 22, thereby improving the effect of reducing the sound.

### Embodiment 3

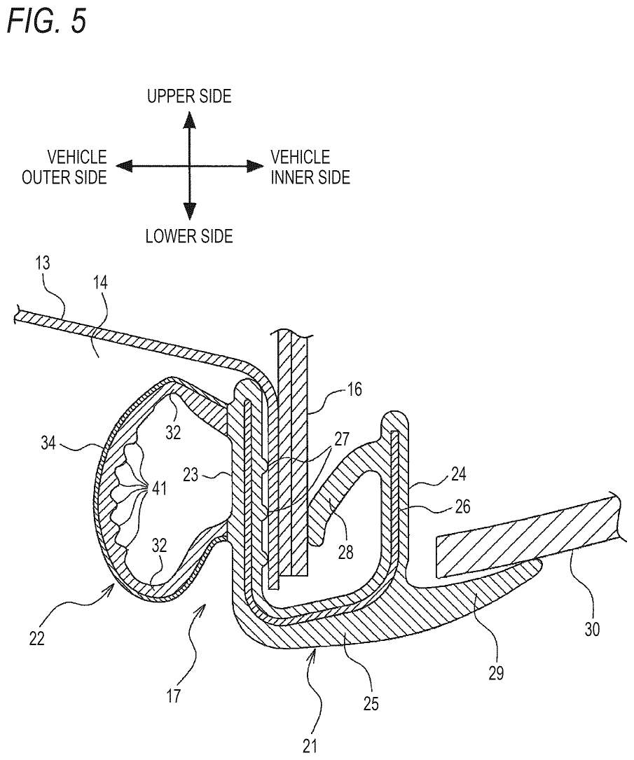

Next, an embodiment 3 of the present invention will be described with reference to FIG. 5. Components that are substantially the same as those in the embodiment 1 described above are denoted by the same reference signs as those in the embodiment 1 described above, the description thereof will be omitted or simplified, and mainly the different components are given different reference signs and described.

In the embodiment 1 described above, the protruding portion 33 that protrudes into the hollow seal portion 22 is formed in a lip shape. In the embodiment 3, a plurality of protruding portions 41 having a small amount of protrusion into the hollow seal portion 22 are integrally formed at a predetermined interval on the inner wall surface of the head side wall portion 31 of the hollow seal portion 22, and are made of the same material as the hollow seal portion 22. The protruding portions 41 have a shape extending in the longitudinal direction of the weather strip 17 by extrusion molding. Since the protruding portion 41 protrudes only a small amount into the hollow seal portion 22, the number of protruding portions 41 is made greater than the number of lip-shaped protruding portions 33 according to the embodiment 1 described above, so that the sound that enters the hollow seal portion 22 is more likely to hit the protruding portions 41, thereby achieving the effect of reducing the sound.

### Embodiment 4

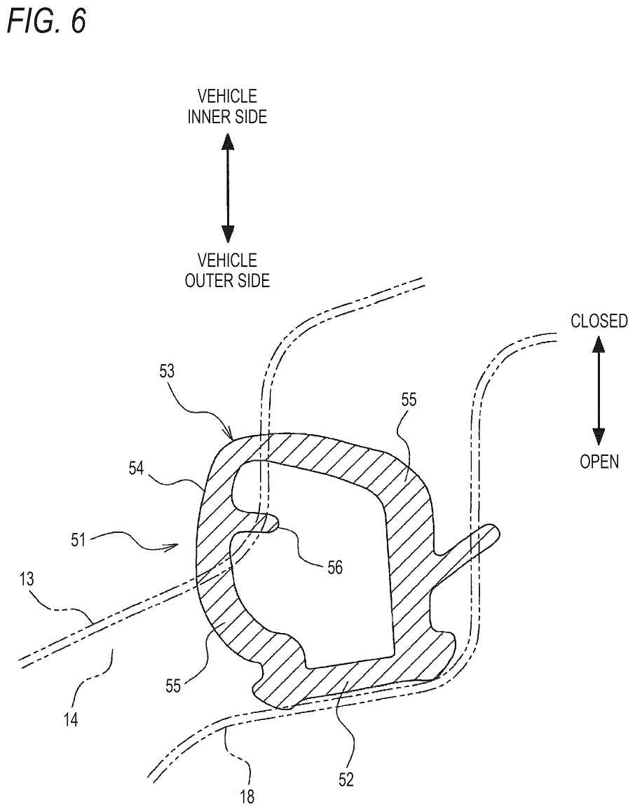

Next, an embodiment 4 of the present invention will be described with reference to FIG. 6. Components that are substantially the same as those in the embodiment 1 described above are denoted by the same reference signs as those in the embodiment 1 described above, the description thereof will be omitted or simplified, and mainly the different components are given different reference signs and described.

The embodiments 1 to 3 described above are all embodiments in which the weather strip 17 is attached to the peripheral edge of the front door opening 14 and the rear door opening 15 of the vehicle body 11. The embodiment 4 is an embodiment in which a weather strip 51 is attached to the peripheral edge of the front door 18 (the rear door 19), which is an opening and closing member, and when the front door 18 (the rear door 19) is closed, the weather strip 51 seals between the peripheral edge of the front door opening 14 (the rear door opening 15) and the front door 18 (the rear door 19).

The weather strip 51 includes a long mounting portion 52 that is mounted along the peripheral edge of the front door 18 (the rear door 19), and a cylindrical hollow seal portion 53 that is integrally formed on the vehicle inner side of the mounting portion 52. The mounting portion 52 and the hollow seal portion 53 extend in the longitudinal direction of the weather strip 51 by extrusion molding.

The hollow seal portion 53 abuts against the peripheral edge of the front door opening 14 (the rear door opening 15) of the vehicle body 11 and is compressed and deformed when the front door 18 (the rear door 19) is closed, thereby sealing between the peripheral edge of the front door 18 (the rear door 19) and the peripheral edge of the front door opening 14 (the rear door opening 15).

The hollow seal portion 53 includes a head side wall portion 54 that is located on a side opposite to the mounting portion 52, and bending portions 55 that are adjacent to both sides of the head side wall portion 54 and that are more easily bent than the other portions of the hollow seal portion 53.

At one or more locations on the inner wall surface of the head side wall portion 54 of the hollow seal portion 53, a lip-shaped protruding portion 56 that protrudes from the inner wall surface into the hollow seal portion 53 is integrally formed of the same material as the hollow seal portion 53. The protruding portions 56 are formed such that the distal ends of the protruding portions 56 do not abut against the inner wall surface of the hollow seal portion 53 when the hollow seal portion 53 is compressed and deformed when the front door 18 (the rear door 19) is closed. The protruding portions 56 have a lip shape extending in the longitudinal direction of the weather strip 51 by extrusion molding.

In the embodiment 4, in consideration of the fact that a portion of the head side wall portion 54 of the hollow seal portion 53 through which the sound is likely to enter is a portion that hits the side panel 13 when the front door 18 (the rear door 19) is closed, the protruding portion 56 is formed at the portion of the head side wall portion 54 of the hollow seal portion 53 that hits the side panel 13, thereby improving the effect of reducing the sound that enters the vehicle. Alternatively, a protruding portion may be formed in another portion of the head side wall portion 54 of the hollow seal portion 53. A protruding portion may be formed in a portion other than the head side wall portion 54 of the hollow seal portion 53.

### Embodiment 5

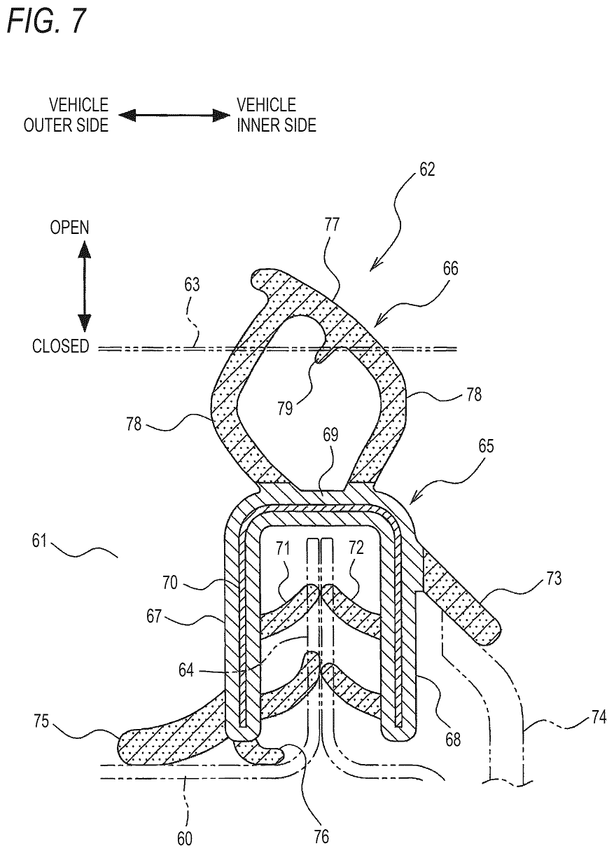

Next, an embodiment 5 of the present invention will be described with reference to FIG. 7. Components that are substantially the same as those in the embodiment 1 described above are denoted by the same reference signs as those in the embodiment 1 described above, the description thereof will be omitted or simplified, and mainly the different components are given different reference signs and described.

In the embodiment 5, a weather strip 62 is attached to a flange 64 that is provided along the peripheral edge of a back door opening 61 of the vehicle body 11, and the peripheral edge of the back door opening 61 and the peripheral edge of a back door 63 are sealed by the weather strip 62 when the back door 63 is closed which is an opening and closing member.

The weather strip 62 includes a mounting portion 65 that has a U-shaped cross section and that is attached to the flange 64 provided along the peripheral edge of the back door opening 61, and a cylindrical hollow seal portion 66 that is integrally formed with the mounting portion 65. The mounting portion 65 and the hollow seal portion 66 extend in the longitudinal direction of the weather strip 62 by extrusion molding.

The mounting portion 65 is integrally formed with a vehicle outer side wall portion 67, a vehicle inner side wall portion 68, and a top wall portion 69 connecting both side wall portions 67 and 68, and the cylindrical hollow seal portion 66 is integrally formed on the outer surface of the top wall portion 69. In the mounting portion 65, a core material 70 that has a substantially U-shaped cross section and that is made of a metal plate, a resin plate, or the like is embedded across both side wall portions 67 and 68 by composite extrusion molding. The weather strip 62 is attached to the flange 64 by clamping the flange 64 that is provided along the peripheral edge of the opening of the back door opening 61 with holding lips 71 and 72 formed integrally on the inner side surfaces of both side wall portions 67 and 68.

A decorative lip 73 that protrudes toward the vehicle inner side is integrally formed on the vehicle inner side wall portion 68 of the mounting portion 65, and this decorative lip 73 covers and hides the gap between the vehicle inner side wall portion 68 of the mounting portion 65 and an interior material 74 on the vehicle inner side. At the vehicle outer side wall portion 67 of the mounting portion 65, seal lips 75 and 76 that protrude toward a back door panel 60 side are integrally formed. The seal lips 75 and 76 seal between the vehicle outer side wall portion 67 of the mounting portion 65 and the back door panel 60.

The hollow seal portion 66 includes a head side wall portion 77 that is located on a side opposite to the mounting portion 65, and bending portions 78 that are adjacent to both sides of the head side wall portion 77 and that are more easily bent than the other portions of the hollow seal portion 66.

At one or more locations on the inner wall surface of the head side wall portion 77 of the hollow seal portion 66, a lip-shaped protruding portion 79 that protrudes from the inner wall surface into the hollow seal portion 66 is integrally formed of the same material as the hollow seal portion 66. The protruding portion 79 is formed such that the distal end of the protruding portion 79 does not abut against the inner wall surface of the hollow seal portion 66 when the hollow seal portion 66 is compressed and deformed when the back door 63 is closed. The protruding portion 79 has a lip shape extending in the longitudinal direction of the weather strip 62 by extrusion molding.

In the embodiment 5, in consideration of the fact that a portion of the head side wall portion 77 of the hollow seal portion 66 through which the sound is likely to enter is a portion that hits the back door 63 when the back door 63 is closed, the protruding portion 79 is formed at the inner wall surface of the portion of the head side wall portion 77 of the hollow seal portion 66 that hits the back door 63, thereby improving the effect of reducing the sound that enters the vehicle. Alternatively, a protruding portion may be formed in another portion of the head side wall portion 77 of the hollow seal portion 66. A protruding portion may be formed in a portion other than the head side wall portion 77 of the hollow seal portion 66.

### Evaluation of Sound Reducing Effect of Weather Strips According to Embodiments 1 to 3

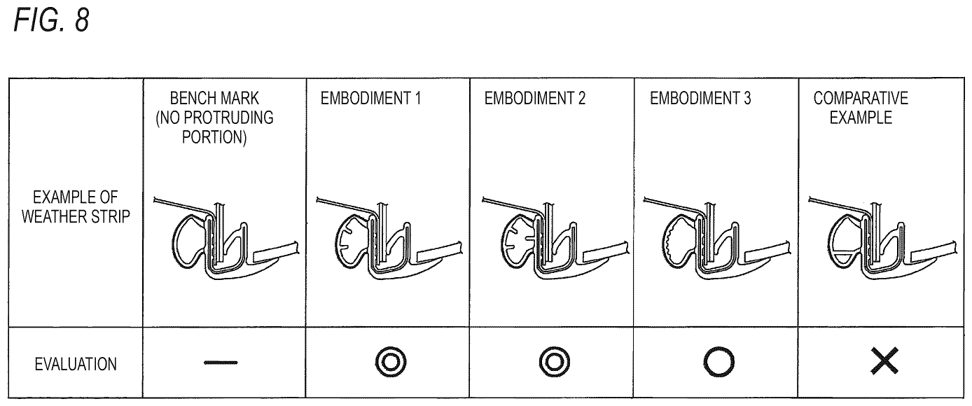

A test was carried out to evaluate the sound reducing effect of the weather strips according to the embodiments 1 to 3, and the results of the evaluation test are shown in FIG. 8. In this evaluation test, a weather strip in which no protruding portion was formed in the hollow seal portion was used as a bench mark, and a weather strip in which the space inside a hollow seal portion was divided by a protruding portion was used as a comparative example. This comparative example corresponds to an example in which the distal end of the protruding portion protruding from the inner wall surface of the hollow seal portion abuts against the inner wall surface of the hollow seal portion. The weather strips according to the bench mark, the embodiments 1 to 3, and the comparative example have the same configuration except for the protruding portions.

In this evaluation test, a sample of a weather strip was placed between a reverberation chamber and a semi-anechoic chamber, noise was generated in the reverberation chamber, and the transmitted sound (dB) was measured in the semi-anechoic chamber. In this case, noise was generated in the general audible range (1000 kHz to 4000 kHz).

The sample was provided in a state in which the mounting portion of the weather strip was fitted to a jig, and the transmitted sounds of the weather strips of five patterns according to the bench mark, the embodiments 1 to 3, and the comparative example were measured. Further, the transmitted sound was also measured in a pattern with only the jig without fitting the weather strip.

The difference between the transmitted sound in the pattern with only the jig and the transmitted sound in the pattern with the weather strip fitted to the jig is defined as the insertion loss.
(Insertion loss)=(transmitted sound with only jig)−(transmitted sound with weather strip fitted to jig)

In the evaluation shown in FIG. 8, for the insertion loss according to each of the examples 1 to 3 and the comparative example, a mark “⊚” indicates that the insertion loss is larger than that in the bench mark by 2 or more, a mark “○” indicates that the insertion loss is larger than that in the bench mark by 1 to 2, and a mark “×” indicates that the insertion loss is smaller than that in the bench mark.

From the results of this evaluation test, it was confirmed that in the embodiments 1 and 2, the insertion loss was larger than that in the bench mark by 2 or more, and the effect of reducing the sound was higher than that in the bench mark.

It was confirmed that in the embodiment 3, the insertion loss was larger than that in the bench mark by 1 to 2, and the effect of reducing the sound was higher than that in the bench mark.

On the other hand, it was confirmed that in the comparative example in which the space in the hollow seal portion was divided by the protruding portion, the insertion loss was smaller than that in the bench mark, and the effect of reducing the sound was not attained.

The results of the evaluation for noise in the general audible range (1000 kHz to 4000 kHz) are as shown in FIG. 8. Similarly, for noise in the low frequency range (500 kHz to 800 kHz) and the high frequency range (5000 kHz to 8000 kHz), by forming a protruding portion inside the hollow seal portion as in the embodiments 1 to 3, the insertion loss can also be made larger than that in the bench mark.

### Other Embodiments

The present invention may be applied to a weather strip that seals between the peripheral edge of an opening of a trunk of a vehicle body and a trunk lid when the trunk lid is closed. The trunk lid is an opening and closing member that opens and closes the opening.

In the embodiments 1 to 5, the bending portion is more easily bent than the other portions of the hollow seal portion. The bending portion is not limited to this, and may be bent when the opening and closing member is closed.

In addition, the present invention is not limited to the embodiments described above, and various modifications may be made, such as changing the structure of the mounting portion of the weather strip, changing the shape and the like of the hollow seal portion, and changing the position and the number of the protruding portions that are formed on the inner wall surface of the hollow seal portion.

### REFERENCE SIGNS LIST

11: vehicle body
14: front door opening
15: rear door opening
16: flange
17: weather strip
18: front door (opening and closing member)
19: rear door (opening and closing member)
21: mounting portion
22: hollow seal portion
23: vehicle outer side wall portion
24: vehicle inner side wall portion
25: top wall portion
31: head side wall portion
32: bending portion
33, 33a, 41: protruding portion
51: weather strip
52: mounting portion
53: hollow seal portion
54: head side wall portion
55: bending portion
56: protruding portion
61: back door opening
62: weather strip
63: back door (opening and closing member)
64: flange
65: mounting portion
66: hollow seal portion
67: vehicle outer side wall portion
68: vehicle inner side wall portion
69: top wall portion
77: head side wall portion
78: bending portion
79: protruding portion

1. A long weather strip for sealing between a peripheral edge of an opening of a vehicle body and an opening and closing member configured to open and close the opening when the opening and closing member is closed, the weather strip comprising:
a hollow seal portion attached to a mounting location of one of the peripheral edge of the opening of the vehicle body and the opening and closing member, the hollow seal portion being configured to be compressed and deformed by abutting against the other of the peripheral edge of the opening of the vehicle body and the opening and closing member when the opening and closing member is closed; and
a mounting portion configured to mount the hollow seal portion on the mounting location, wherein
the hollow seal portion includes a head side wall portion that is located on a side opposite to the mounting portion, and a bending portion adjacent to both sides of the head side wall portion and configured to bend when the opening and closing member is closed,
in the hollow seal portion, a protruding portion that protrudes from an inner wall surface of the head side wall portion is formed of the same material as the hollow seal portion, and
the protruding portion is formed such that a distal end of the protruding portion does not abut against an inner wall surface of the hollow seal portion when the hollow seal portion is compressed and deformed by closing the opening and closing member.

2. The weather strip according to claim 1, wherein
the protruding portion is formed in a lip shape extending into the hollow seal portion.

3. The weather strip according to claim 1, wherein
the protruding portion includes a plurality of protruding portions, and
each of the protruding portions is formed at a plurality of locations on the inner wall surface of the head side wall portion at a predetermined interval.

4. The weather strip according to claim 3, wherein
the protruding portions are formed, in the inner wall surface of the hollow seal portion, on both the inner wall surface of the head side wall portion and a different inner wall surface other than the inner wall surface of the head side wall portion, such that the protruding portions do not abut against each other when the hollow seal portion is compressed and deformed by closing the opening and closing member.

5. The weather strip according to claim 1, wherein
the bending portion is thinner than a portion of the hollow seal portion other than the bending portion.

6. The weather strip according to claim 1, wherein
the weather strip is a door opening that is attached to the peripheral edge of the opening of the vehicle body.
